(19) United States
(12) Patent Application Publication
(10) Pub. No.: US 2025/0008538 A1
(43) Pub. Date: Jan. 2, 2025

(54) CAPABILITY REPORTING FOR ANTENNA SWITCHING (AS) SOUND REFERENCE SIGNAL (SRS) SOUNDING

(71) Applicant: APPLE INC., Cupertino, CA (US)

(72) Inventors: Haitong SUN, Cupertino, CA (US); Chunxuan YE, Cupertino, CA (US); Dawei ZHANG, Cupertino, CA (US); Hong HE, Cupertino, CA (US); Huaning NIU, Cupertino, CA (US); Sigen YE, San Diego, CA (US); Wei ZENG, Cupertino, CA (US); Yushu ZHANG, Beijing (CH)

(73) Assignee: APPLE INC., Cupertino, CA (US)

(21) Appl. No.: 18/707,711

(22) PCT Filed: Nov. 5, 2021
(86) PCT No.: PCT/CN2021/129032

§ 371 Date: May 6, 2024

(51) Int. Cl. H04W 72/51; H04L 5/00; H04W 24/08; H04W 72/0446; H04W 72/566

(52) U.S. Cl. CPC H04W 72/51; H04L 5/0051; H04W 24/08; H04W 72/0446; H04W 72/566

(57) ABSTRACT

Embodiments are disclosed for capability reporting for antenna switching, AS, sound reference signals, SRS. A user equipment (UE) can transmit a capability report for AS SRS that includes a plurality of receive antenna (e.g., six or eight receive antenna), and receive SRS instructions based on the capability report. The UE can transmit a first temporary capability reduction for a duration, and transmit a first SRS according to the first temporary capability reduction and the SRS instructions, while maintaining phase continuity. To maintain phase continuity, the UE can calibrate one or more SRS ports participating in the AS SRS to transmit with substantially a same transmit power. The UE can determine that a second SRS overlaps an other transmission in a time domain, determine that the other transmission has an absolute priority over the second SRS, and transmit the other transmission but not the second SRS.

### BACKGROUND

### Field

The embodiments relate generally to reporting capabilities corresponding to antenna switching (AS) Sounding Reference Signal (SRS) sounding in a wireless communication system.

### SUMMARY

Some embodiments include an apparatus, method, and computer program product for network configuration and user equipment (UE) capability reporting for Sounding Reference Signal (SRS) sounding in a wireless network. Some embodiments include a UE reporting one or multiple options supporting channel sounding with antenna switching supporting a plurality of receive antenna. In some embodiments the reporting includes a bitmap. Some embodiments include a UE reporting a capability reduction for a time duration, via radio resource control (RRC) signaling, a Media Access Control (MAC)-control element (CE) signaling, and/or layer 1 signaling. Some embodiments include the UE reporting to a network (e.g., a base station (BS)) reciprocity based channel sounding, where the UE can: freeze power control for open loop and/or closed loop power control for SRS resources, drop SRS resources for SRS antenna switching based on a priority of an overlapping transmission, or indicate a capability to maintain phase continuity after a duplexing direction change. In some embodiments, a UE can report a minimum gap, Y, between different SRS resources for antenna switching SRS for subcarrier spacing (SCS) of 240 kHz, 480 kHz, and 960 kHz. The reporting can include a single report for all SRS resources in the SRS antenna switching, or the UE can report whether the UE requires a minimum gap, Y, between each pair of adjacent SRS resources in SRS antenna switching. In some embodiments the UE can indicate a slot offset for flexible aperiodic (AP) SRS via RRC configuration, or the flexible AP-SRS slot offset can correspond to the bandwidth part (BWP) or a component carrier (CC) corresponding to the UE.

In some embodiments, the UE can transmit a capability report for AS SRS, where the capability report is associated with a plurality of receive antenna, e.g. six or eight receive antenna, and the UE receives SRS instructions based on the capability report. The UE can transmit a first temporary capability reduction for a duration, and transmit a first SRS according to the first temporary capability reduction and the SRS instructions, while maintaining phase continuity. To maintain phase continuity, the UE can calibrate one or more SRS ports participating in the AS SRS to transmit with substantially the same transmit power level.

The UE can determine that a second SRS overlaps another transmission in a time domain, determine that the other transmission has an absolute priority over the second SRS, and transmit the other transmission but not the second SRS. In some embodiments, the UE can determine that a second SRS overlaps another transmission in a time domain, determine that the other transmission does not have an absolute priority over the second SRS, and transmit the second SRS. In addition, the UE can scale a transmit power corresponding to the other transmission to satisfy a radio frequency requirement, and transmit the other transmission.

In some embodiments, the UE cannot maintain phase continuity with a duplexing direction change between a first SRS resource and a second SRS resource. Accordingly, the UE can: i) monitor a downlink (DL) channel without transmitting the first or the second SRS resource; or ii) transmit the first SRS resource and the second SRS resource without monitoring the DL channel between the transmissions. In some embodiments, the UE can maintain phase continuity with a duplexing direction change between a first SRS resource and a second SRS resource. The UE can transmit the first SRS resource, monitor the DL channel, and transmit the second SRS resource (e.g., to the BS.)

In some embodiments, the UE can detect a list of slot offsets in an aperiodic SRS-ResourceSet, and count slots for a slot offset based on available slots. In some embodiments, the capability report includes a bitmap, where a bit of the bitmap corresponds to an SRS transmit port switching capability. In some embodiments, the first temporary capability reduction is carried via RRC signaling, MAC-CE signaling, or layer 1 signaling. In some embodiments, the first temporary capability reduction corresponds to a first predefined time window, where the UE can transmit a second temporary capability reduction outside of the first predefined time window.

In some embodiments, a BS can receive a capability report for AS SRS, where the capability report includes six or eight receive antenna. The BS can transmit AS SRS instructions based on the capability report, and receive a first temporary capability reduction for a duration. Subsequently, the BS can receive a first SRS and a second SRS according to the first temporary capability reduction and the AS SRS instructions, where the first SRS and the second SRS have phase continuity. The BS can measure an uplink propagation channel corresponding to the first SRS and the second SRS, and estimate a downlink propagation channel based on the measurement of the first and the second SRS.

### BRIEF DESCRIPTION OF THE FIGURES

The accompanying drawings, which are incorporated herein and form part of the specification, illustrate the presented disclosure and, together with the description, further serve to explain the principles of the disclosure and enable a person of skill in the relevant art(s) to make and use the disclosure.

FIG. 1 illustrates an example system for antenna switching (AS) sound reference signals (SRS) in accordance with some embodiments of the disclosure.

FIG. 2 illustrates a block diagram of an example wireless system for AS SRS, according to some embodiments of the disclosure.

FIG. 3 illustrates example systems supporting AS SRS, according to some embodiments of the disclosure.

FIG. 4A illustrates an example of a collision with AS SRS, according to some embodiments of the disclosure.

FIG. 4B illustrates an example for maintaining phase continuity for AS SRS based on a collision, according to some embodiments of the disclosure.

FIG. 5 illustrates another example for maintaining phase continuity for AS SRS based on a duplexing direction change, according to some embodiments of the disclosure.

FIG. 6 illustrates an example method for a user equipment (UE) maintaining phase continuity for AS SRS based on a time domain collision, according to some embodiments of the disclosure.

FIG. 7 illustrates another example method for a UE maintaining phase continuity for AS SRS regarding a duplexing direction change, according to some embodiments of the disclosure.

FIG. 8 illustrates an example method for a UE configuring a flexible slot offset for AS SRS, according to some embodiments of the disclosure.

FIG. 9 is an example computer system for implementing some embodiments or portion(s) thereof.

The presented disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

In a wireless communications system, a base station (BS) (e.g., a 5G Node B, gNB), can receive a Sounding Reference Signal (SRS) from a user equipment (UE) to measure an uplink (UL) propagation channel. The BS can also use the SRS from the UE for downlink (DL) sounding to estimate the DL propagation channel when channel reciprocity exists. For example, channel reciprocity exists when a number (x) of transmit paths (T) at the UE equals a number (y) of receive antenna (R) at the UE (e.g., xTyR, where x and y are equal.) When the number of transmit paths, xT, is less than the number of receive antenna, yR, then the UE performs antenna switching (AS) to allow the SRS to be transmitted from each receive antenna (R). The UE informs the BS of this capability to perform AS SRS by reporting capabilities to the BS.

Some embodiments include UE capability reporting for AS SRS including minimum gap Y between SRSs, methods for ensuring phase continuity for AS SRS, and conjurations of flexible aperiodic (AP)-SRS slot offset indication.

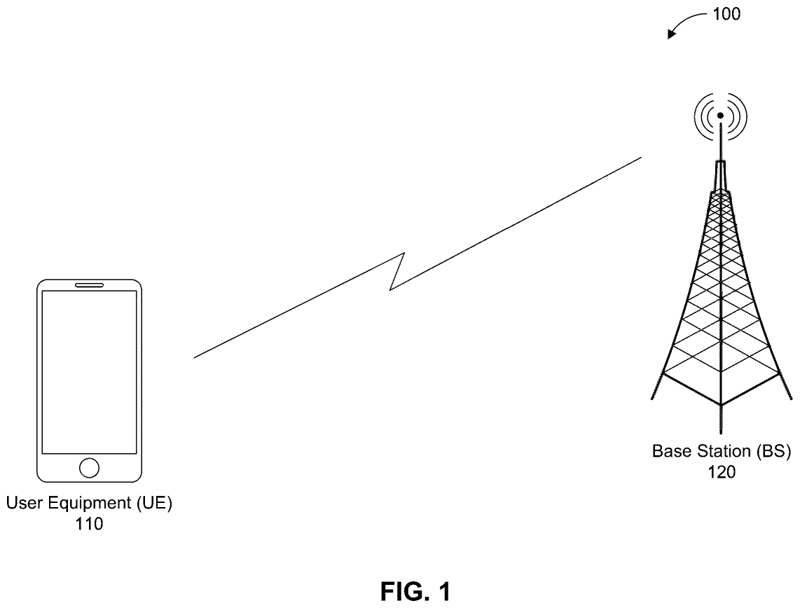

FIG. 1 illustrates example system 100 for AS SRS, in accordance with some embodiments of the disclosure. System 100 includes UE 110 that communicates with BS 120 via a wireless communications. The wireless communications can include but is not limited to 5G communications as defined by 3rd Generation Partnership Project (3GPP) standards. For example, UE 110 and/or BS 120 can include an electronic device configured to operate using a 3GPP release, such as 3GPP NR RAN1 Release 17 (Rel-17), or other 3GPP standards. UE 110 and BS 120 can operate in Frequency Range 1 (FR1) and/or Frequency Range 2 (FR2). UE 110 may be a computing electronic device such as a smart phone, cellular phone, and for simplicity purposes—may include other computing devices including but not limited to laptops, desktops, tablets, personal assistants, routers, monitors, televisions, printers, and appliances. BS 120 can be a gNB or a transmission point (TRP). UE 110 can report capabilities supporting AS SRS, for example to BS 120, and BS 120 can transmit instructions to UE 110 for transmitting SRS to BS 120. BS 120 can utilize received SRS to measure an uplink propagation channels corresponding to the SRS. When the uplink and downlink channels are reciprocal, BS 120 can also use the received SRS signals to estimate a downlink propagation channel corresponding to the received SRS.

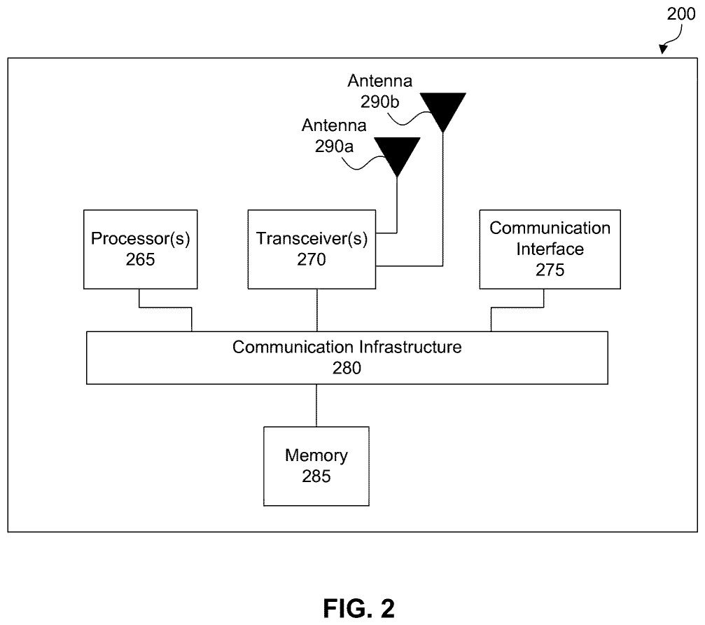

FIG. 2 illustrates a block diagram of example wireless system 200 for AS SRS, according to some embodiments of the disclosure. For explanation purposes and not a limitation, FIG. 2 may be described with reference to elements from FIG. 1. For example, system 200 may be any of the electronic devices (e.g., UE 110 or BS 120) of system 100.

System 200 includes one or more processors 265, transceiver(s) 270, communication interface 275, communication infrastructure 280, memory 285, and antenna 290. Memory 285 may include random access memory (RAM) and/or cache, and may include control logic (e.g., computer instructions) and/or data. One or more processors 265 can execute the instructions stored in memory 285 to perform operations enabling wireless system 200 to transmit and receive wireless communications, including reporting capabilities for AS SRS as described herein. In some embodiments, one or more processors 265 can be “hard coded” to perform the functions herein. Transceiver(s) 270 transmits and receives wireless communications signals including wireless communications supporting capability reporting for AS SRS according to some embodiments, and may be coupled to one or more antenna 290 (e.g., 290a, 290b). In some embodiments, a transceiver 270a (not shown) may be coupled to antenna 290a and different transceiver 270b (not shown) can be coupled to antenna 290b. Communication interface 275 allows system 200 to communicate with other devices that may be wired and/or wireless. Communication infrastructure 280 may be a bus. Antenna 290 may include one or more antenna that may be the same or different types.

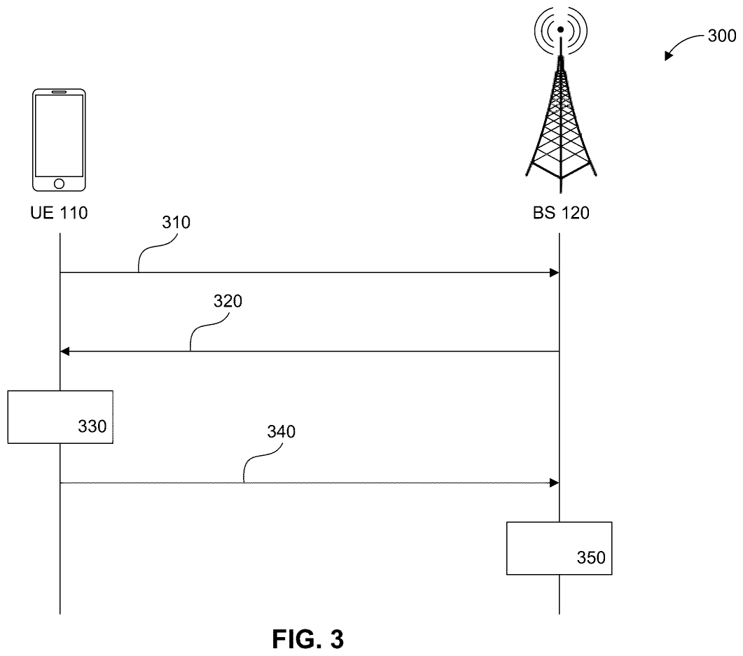

FIG. 3 illustrates example 300 of systems supporting AS SRS, according to some embodiments of the disclosure. As a convenience and not a limitation, example 300, may be described with elements of other figures herein. For explanation purposes and not a limitation, FIG. 3 may be described with reference to elements from FIG. 1 and/or FIG. 2. Example 300 can include, for example, UE 110 and BS 120 of FIG. 1, where UE 110 and/or BS 120 may be implemented by system 200 of FIG. 2. The following is an overview of example 300 followed by detailed descriptions.

At 310, UE 110 can report capabilities of UE 110 to support AS SRS. The reported capabilities can be received by BS 120. BS 120 can adjust UL scheduling, DL scheduling, as well as SRS scheduling accordingly.

At 320, BS 120 can transmit SRS instructions to UE 110 based at least on the reported capabilities of UE 110.

At 330, UE 110 can perform methods according to the reported capabilities and the SRS instructions received from BS 120. For example, managing SRS based on maintaining channel reciprocity in the event of potential collisions and/or duplexing directional changes, as well as determining slot offsets according to release schemes.

At 340, UE 110 can transmit SRS with AS accordingly.

At 350, BS 120 can receive SRS and assess UL propagation channels. When the UL and DL channels are reciprocal (e.g., phase continuity is maintained between UL and DL channels), BS 120 can also use the received SRS signals to estimate a downlink propagation channel corresponding to the received SRS.

### At 310:

UE 110 can report capabilities of UE 110 to support AS SRS. In some embodiments, the capabilities of UE 110 include support for AS SRS with 6 receive antenna (6R) and/or 8 receive antenna (8R). For example, UE 110 can transmit one or more capabilities to support SRS transmit port switching (e.g., srs-TxSwitch) for AS SRS: {4T8R, 2T4R, 1T2R}. For example, when implementing 4T8R, UE 110 can have the capability for 4 transmit paths switching between 8 receive antenna; for 2T4R, UE 110 includes 2 transmit paths switching between 4 receivers; for 1T2R, UE 110 includes one transmit path switching between 2 receivers. Other examples of capabilities include but are not limited to: {4T8R}, {4T8R, 2T4R}, {2T8R}, {2T8R, 1T4R}, {1T8R}, {1T8R, 1T4R}, {1T8R, 1T4R, 1T2R}, {1T8R, 1T4R, 1T2R, 1T1R}, {4T6R}, {4T6R, 4T4R}, {2T6R}, {2T6R, 2T4R}, {2T6R, 2T4R, 2T2R}. In some embodiments, to report the capabilities, UE 110 can utilize a bitmap. For example, a 12 bit bitmap can be transmitted to BS 120 to report a preferred SRS transport port switching capability and/or fallback capabilities. An example of a 12 bit bitmap includes but is not limited to the following where a bit of the bit map corresponds to a different SRS transport port switching capability: {1T1R, 1T2R, 2T2R, 1T4R, 2T4R, 4T4R, 1T6R, 2T6R, 4T6R, 1T8R, 2T8R, 4T8R}. Other bit map sizes are possible.

In some embodiments, UE 110 can report a temporary capability reduction in terms of transmit or receive capabilities. For example, for power and thermal considerations, UE 110 may temporarily reduce a number of active transmit power amplifiers (PAs) and/or a number of active receive antenna. The temporary SRS transmit port switching capability reporting can be transmitted via radio resource control (RRC) signaling, a Media Access Control (MAC)-control element (CE) signaling, and/or layer 1 signaling, for example. In some embodiments the temporary SRS transmit port switching capability reporting includes a time duration after which, UE 110 reverts back to a most recent SRS transmit port switching capability, or a preferred SRS transmit port switching capability. In some embodiments, after UE 110 reports and implements a first temporary SRS transmit port switching capability, UE 110 is prohibited from reporting and implementing a second temporary SRS transmit port switching capability within a predefined time window. For example, a prohibit-timer may be implemented corresponding to the predefined time window. As an example and not a limitation, UE 110 can transmit a report including but not limited to one or more of the following temporary SRS transmit port switching capabilities as shown below in Table 1. Examples of temporary capability reductions.

TABLE 1
Examples of temporary capability reductions.

| | |
|---|---|
| 4T8R | 4T/6R, 4T/4R, 2T/8R, 2T/6R, 2T/4R, 2T/2R, 1T/8R, 1T/6R, |
| | 1T/4R, 1T/2R, 1T/1R |
| 2T8R | 2T/6R, 2T/4R, 2T/2R, 1T/8R, 1T/6R, 1T/4R, 1T/2R, 1T/1R |
| 1T8R | 1T/6R, 1T/4R, 1T/2R, 1T/1R |
| 4T6R | 4T/4R, 2T/6R, 2T/4R, 2T/2R, 1T/6R, 1T/4R, 1T/2R, 1T/1R |
| 2T6R | 2T/4R, 2T/2R, 1T/6R, 1T/4R, 1T/2R, 1T/1R |
| 1T6R | 1T/4R, 1T/2R, 1T/1R |
| 4T4R | 2T/4R, 2T/2R, 1T/4R, 1T/2R, 1T/1R |
| 2T4R | 2T/2R, 1T/4R, 1T/2R, 1T/1R |
| 1T4R | 1T/2R, 1T/1R |
| 2T2R | 1T2R, 1T1R |

In some embodiments, UE 110 reports to BS 120 (e.g., a wireless network) a capability of UE 110 to support reciprocity based channel sounding. For example, to support reciprocity based channel sounding, UE 110 transmit ports and receive antenna are calibrated such that a DL channel is reciprocal (e.g., similar) to an UL channel. In some embodiments, UE 110 can set the transmit power (e.g., maximum transmit power level) to be the same for every SRS port participating in AS SRS sounding.

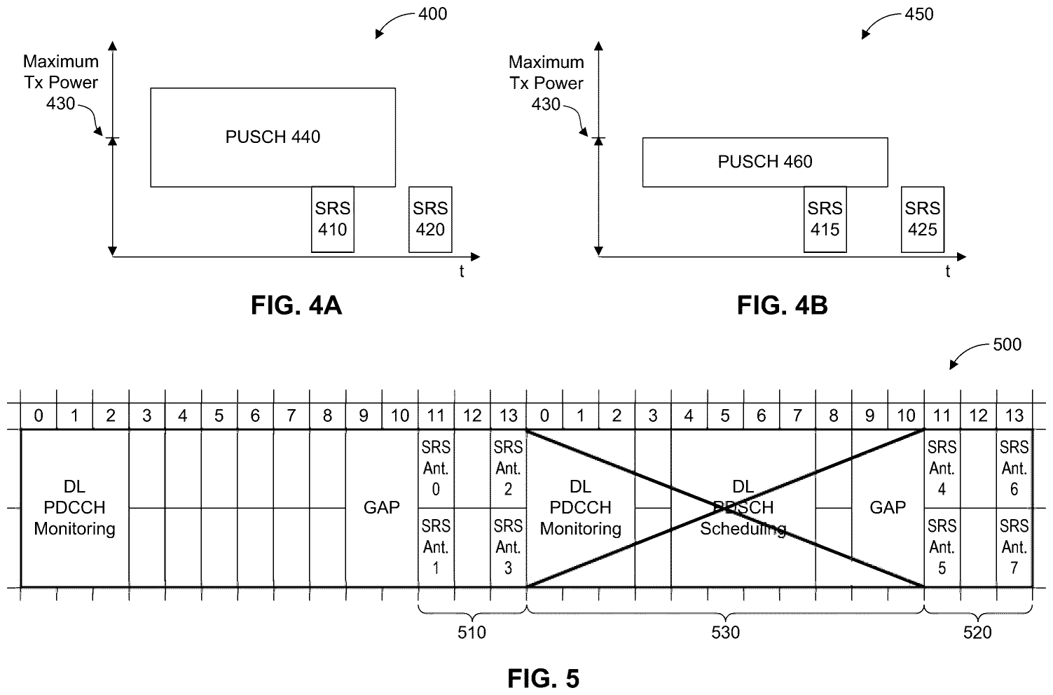

FIG. 4A illustrates example 400 of a collision with AS SRS, according to some embodiments of the disclosure. For explanation purposes and not a limitation, FIG. 4A may be described with reference to elements from earlier FIGS. Example 400 can be performed by UE 110 of FIG. 1, or system 200 of FIG. 2. When multiple physical layer (PHY) channels transmit at the same time a collision or an overlap can occur. For example, when carrier aggregation (CA) or dual connectivity (DC) are implemented, a collision or overlap can occur within the same cell. In example 400, UE 110 determines that SRS 410 overlaps with Physical Uplink Shared Channel (PUSCH) 440 in the time domain such that the maximum transmission power level 430 is exceeded. This presents a problem for UE 110 to support reciprocity based channel sounding where each SRS transmit port should transmit at substantially the same transmit power.

FIG. 4B illustrates example 450 for maintaining phase continuity for AS SRS based on a collision, according to some embodiments of the disclosure. For explanation purposes and not a limitation, FIG. 4B may be described with reference to elements from earlier FIGS. Example 450 can be performed by UE 110 of FIG. 1, or system 200 of FIG. 2 based on example 400 of FIG. 4A. In some embodiments, UE 110 can determine that PUSCH 460 has a higher priority than SRS 415 (e.g., PUSCH 460 may correspond to an ultra reliable low latency communication (URLLC)) and thus has higher priority over AS SRS sounding. If PUSCH 460 has a higher or absolute priority over the SRS 415, then UE 110 does not transmit SRS. For example, UE 110 can transmit PUSCH 460 and drop SRS 415 and SRS 425 (not shown) so that maximum transmit power level 430 is not exceeded. In some embodiments, a power level of PUSCH 460 may be scaled so that maximum transmit power level 430 is not exceeded.

In an embodiment, UE 110 determines that PUSCH 460 does not have a higher or absolute priority over SRS 415, and in example 450, UE 110 transmits SRS 415 and 425. In some embodiments, UE 110 may scale (e.g., reduce) the transmit power of PUSCH transmission 460 to satisfy radio frequency (RF) requirements (e.g., maximum power reduction (MPR), Power control max (PCMAX)). Example 450 shows that a scaled PUSCH 460 is transmitted. SRS 415 and 425 transmit power may not be scaled.

In some embodiments, UE 110 reports to BS 120 a capability of UE 110 to maintain phase continuity after a duplexing direction change. For example, UE 110 informs BS 120 whether or not UE 110 can transmit an SRS resource in the last symbol of a first slot, and perform a duplexing direction change (e.g., perform DL monitoring) in a first symbol of a second slot. In some embodiments, UE 110 can perform the duplexing direction change and transmit a subsequent SRS resource in a last symbol of the second slot to support AS SRS. In some embodiments, UE 110 cannot perform the duplexing direction change in time to support AS SRS. Accordingly, UE 110 can choose to not perform DL monitoring between SRS resources for AS SRS and transmits SRS resources supporting AS SRS. In some embodiments, UE 110 can choose to drop SRS resources for AS SRS while maintaining DL operations. When UE 110 can perform the duplexing direction change in time to support AS SRS, UE 110 can transmit a first SRS resource supporting AS SRS, perform duplexing direction change (e.g., monitor DL channels), and subsequently transmit a second SRS resource supporting the AS SRS.

FIG. 5 illustrates example 500 for maintaining phase continuity for AS SRS based on a duplexing direction change, according to some embodiments of the disclosure. For explanation purposes and not a limitation, FIG. 5 may be described with reference to elements from earlier FIGS. Example 500 can be performed by UE 110 of FIG. 1, or system 200 of FIG. 2. Example 500 illustrates that UE 110 cannot maintain phase continuity for AS SRS based on a duplexing direction change. Accordingly, UE 110 chooses to transmit SRS resource 510 and SRS resource 520, and does not perform DL monitoring for a duration shown by 530. In some embodiments, UE 110 can choose not to transmit SRS resource 510 and 520 and instead perform DL monitoring (not shown). Thus, UE 110 can report to BS 120 a capability of UE 110 to maintain phase continuity after a duplexing direction change, and whether UE 110 can: i) perform DL monitoring and drop SRS resource 510 and 520 (not shown); or ii) not perform DL monitoring (e.g., for the duration 530) and transmit SRS resource 510 and 520.

In some embodiments, UE 110 can report a minimum gap, Y, for subcarrier spacing (SCS) introduced for certain frequencies, e.g. greater than 52.6 GHz: e.g., 240/480/960 kHz SCS. A minimum gap, Y, is the minimum number of symbols between SRS resources of an SRS resource set for antenna switching needed for UE 110 perform AS SRS. For example, SRS resource set 510 of FIG. 5 illustrates a minimum gap Y=1 symbol between SRS resources. SRS resource set 520 of FIG. 5 also illustrates a minimum gap Y=1 symbol between SRS resources. In some embodiments, UE 110 reports the minimum gap, Y, capability at 310 of example 300. In some embodiments, the minimum gap, Y, is hardcoded assuming the same time as 120 kHz. Thus, the minimum gap, Y, for the corresponding SCS values greater than 52.6 GHz are shown below in Table 2. Minimum guard period between two SRS resources of an SRS resource set for antenna switching.

TABLE 2
Minimum guard period between two SRS resources
of an SRS resource set for antenna switching

| μ | Δf = 2^{μ} · 15[kHz] | Y[symbol] |
|---|---|---|
| 0 | 15 | 1 |
| 1 | 30 | 1 |
| 2 | 60 | 1 |
| 3 | 120 | 2 |
| 4 | 240 | 4 |
| 5 | 480 | 8 |
| 6 | 960 | 16 |

In some embodiments, UE 110 reports whether the minimum gap, Y, between different SRS resources in AS SRS is needed. For example, UE 110 can provide a single indication of whether UE 110 requires or does not require the minimum gap, Y, for various SRS resources for AS SRS. When UE 110 requires the minimum gap, Y, BS 120 can schedule SRS resource sets with the corresponding minimum gap, Y, between received SRS resources. When UE 110 does not require the minimum gap, Y, BS 120 can schedule SRS resources of an SRS resource set to be received sooner than the corresponding minimum gap Y.

In some embodiments, UE 110 can report whether UE 110 requires a minimum gap Y between each pair of adjacent SRS resources in AS SRS. For example, for 2T6R antenna switching, UE 110 can be configured with 3 SRS resources for antenna switching (SRS1, SRS2, SRS3.) UE 110 can independently report whether UE 110 needs a minimum gap Y between SRS1/SRS2 (e.g., no minimum gap Y needed) and SRS2/SRS3 (minimum gap Y needed.) For AS SRS of 1T8R, 7 pairs of adjacent SRS resources are needed. UE 110 can inform BS 120 of which pairs need the minimum gap Y and which do not. When the minimum gap Y is not needed, the network (via BS 120) can complete SRS sounding assessments in a shorter time period. Thus, the chances of UE 110 having to address a collision and/or a duplexing direction change can be reduced. UE 110 increases power consumption when no minimum gap Y exists between SRS resources as UE 110 quickly switches a transmit path from one receive antenna to another.

BS 120 receives the capability report transmitted at 310 by UE 110.

### At 320:

At 320, BS 120 can transmit AS SRS instructions based on the received capabilities reported at 310 described above. For example, if UE 110 reports that duplexing direction change is not supported, then BS 120 may avoid scheduling a duplexing direction change between two SRS resources for AS SRS sounding. UE 110 receives the AS SRS instructions and performs AS SRS sounding accordingly.

In some embodiments, a wireless network (e.g., via BS 120) can explicitly indicate to UE 110 which release scheme is implemented (e.g., slot offset indication in 3GPP NR RAN1 Rel-15/16 or slot offset indication in Rel-17) for aperiodic (AP)-SRS slot offset determination. RRC signaling can be used to indicate the explicit configuration of a release scheme (e.g., Rel-15/16 or Rel-17 scheme) implemented. Thus, when UE 110 receives the explicit indication, UE 110 can apply the appropriate release scheme rules for identifying an aperiodic AP-SRS slot offset relative to a Downlink Control Indication (DCI) signal received. Consequently, UE 110 does not have to examine an SRS-ResourceSet to determine whether a slot offset is based on any slot counted or only based on counted available slots. For example, when UE 110 receives an indication (e.g., an information element) for Rel-15/16, the slotOffset is determined based on any slot. When UE 110 receives an indication for Rel-17, the slotOffset is determined based only on available slots. In other words, the counting for the slot offset in Rel-17 ignores slots that are not available.

In some embodiments, instead of receiving an explicit indication of which release scheme is supported, UE 110 examines any AP SRS-ResourceSet to determine whether an information element includes a list of slot offsets. If a list of slot offsets in any AP SRS-ResourceSet is found, then UE 110 determines the slot offset based only on available slots that are counted (e.g., Rel-17). If however, a slot offset is included in all AP SRS-ResourceSets but not in a list, then UE 110 determines the slot offset based on any slots that are counted (e.g., Rel-15/16). The information element with the list of slot offsets can be configured with BS 120 via RRC signaling. In some embodiments, all the bandwidth parts (BWP) corresponding to a component carrier (CC) utilize a same release scheme (e.g., all use a list of slot offsets in any AP SRS-ResourceSet or all use a single slot offset.) In some embodiments each BWP of a CC can use a different release scheme. Thus, a first BWP corresponding to a CC may use a list of slot offsets (Rel-17) while a second BWP may not use a list of slot offsets (Rel-15/16.) Correspondingly, to check whether a list of slot offsets is configured in any AP SRS-ResourceSet in order to determine whether it is Rel-15/16 scheme or Rel-17 scheme, the check can be performed based on either any AP SRS-ResourceSet per BWP, or, any AP SRS-ResourceSet per CC.

In some embodiments, BS 120 can transmit instructions to trigger an AP SRS (e.g., via a DCI signal). If UE 110 detects a Slot Offset Indicator (SOI) field (e.g., a maximum of 2 bits) of the DCI signal, then UE 110 determines that the wireless network is implementing Rel-17, and UE 110 can index the value to a list of a maximum of 4 slot offsets that are configured per AP SRS-ResourceSet via RRC signaling. The slot offset for Rel-17 is determined based only on available slots rather than any slots.

At 330 (and 340 when SRS Resources are Transmitted to BS 120):

At 330, in response to UE 110 reporting to BS 120 a capability to support reciprocity based channel sounding, UE 110 transmit ports and receive antenna can be calibrated such that a DL channel is reciprocal (e.g., similar) to an UL channel. UE 110 may ensure phase continuity for AS SRS between UE 110 and BS 120. A transmitter that has phase continuity has the ability to maintain the same phase when transmitting signals/waveforms at different times. In some embodiments, UE 110 can set power control for SRS resources for AS SRS (e.g., open loop and close loop power controls). By setting the power controls, for example, UE 110 can ensure that substantially the same transmit power level is used at a SRS port participating in AS SRS sounding.

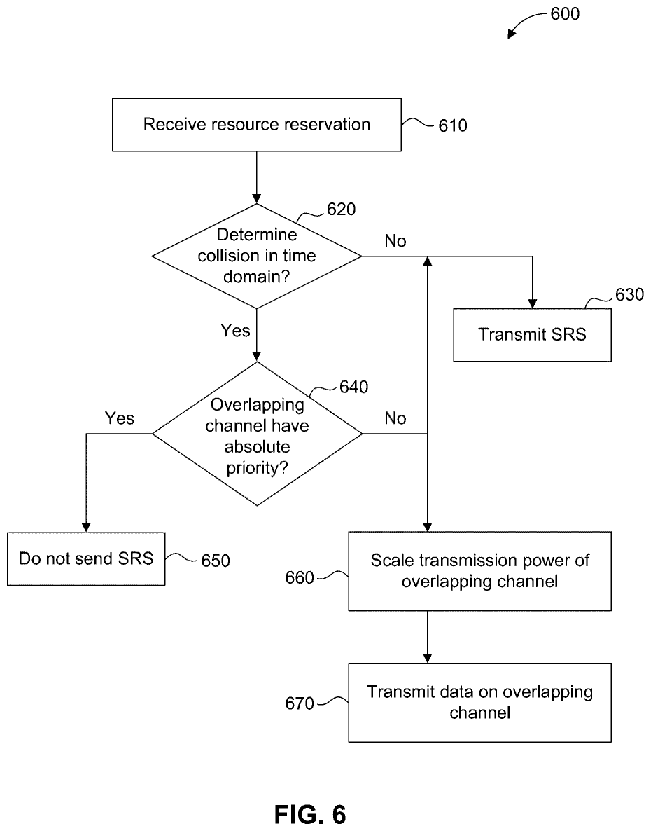

FIG. 6 illustrates example method 600 for a UE maintaining phase continuity for AS SRS based on a time domain collision, according to some embodiments of the disclosure. For explanation purposes and not a limitation, FIG. 6 may be described with reference to elements from earlier FIGS. For example, method 600 can be performed by UE 110 of FIG. 1, or system 200 of FIG. 2.

At 610, UE 110 can receive a resource reservation from BS 120. For example, UE 110 can receive at 320 of FIG. 3, an SRS resource reservation with instructions for performing AS SRS.

At 620, UE 110 can determine whether a collision in the time domain may occur and the collision may cause a maximum transmit power level to be exceeded. When UE 110 determines that no collisions (e.g., overlap) between a scheduled transmission (e.g., a PUSCH transmission) and an SRS resource will cause a maximum transmit power level to be exceeded, method 600 proceeds to 630. Otherwise, method 600 proceeds to 640.

At 630, UE 110 proceeds to transmit SRS according to AS SRS instructions received from BS 120.

At 640, when a collision (e.g., overlap) between a scheduled transmission (e.g., scheduled PUSCH transmission) and an SRS resource is determined and the collision may cause a maximum transmit power level to be exceeded, UE 110 determines whether the overlapping channel (e.g., scheduled PUSCH transmission) has a higher or absolute priority over the SRS resource. When UE 110 determines that the overlapping channel has a higher or absolute priority over the SRS resource, method 600 proceeds to 650. Otherwise, method 600 proceeds to 630 to transmit SRS. In some embodiments, method 600 also proceeds to 660.

At 650, the overlapping channel has a higher or absolute priority over the SRS resource so UE 110 does not transmit SRS. In some embodiments, method 600 may proceed to 660.

At 660, if UE 110 determines that the scheduled PUSCH transmission exceeds the maximum transmit power level, and UE 110 can scale the transmission power level of the scheduled PUSCH transmission such that the overlap (e.g., combination of power levels) of the SRS transmitted and the scheduled PUSCH transmission satisfy (e.g., do not exceed) the maximum transmit power level.

At 670, UE 110 transmits the scheduled PUSCH transmission.

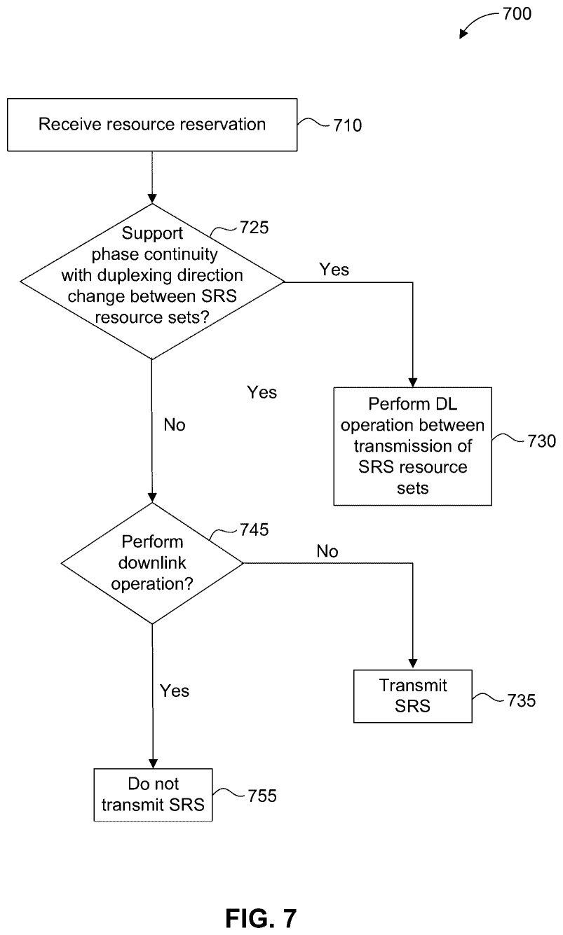

FIG. 7 illustrates example method 700 for UE 110 maintaining phase continuity for AS SRS regarding a duplexing direction change, according to some embodiments of the disclosure. For explanation purposes and not a limitation, FIG. 7 may be described with reference to elements from earlier FIGS. For example, method 700 can be performed by UE 110 of FIG. 1, or system 200 of FIG. 2.

At 710, UE 110 can receive a resource reservation from BS 120. For example, UE 110 can receive at 320 of FIG. 3, an SRS resource reservation with instructions for performing AS SRS.

At 725, UE 110 can determine whether phase continuity with duplexing direction change between SRS resources for AS SRS is supported. If for example, UE 110 indicated at 310 of FIG. 3 that phase continuity with duplexing direction change between SRS resources for AS SRS is supported, then method 700 proceeds to 730. Otherwise, method 700 proceeds to 745.

At 730, UE 110 performs DL operations between transmissions of SRS resources. For example, UE 110 can transmit a first SRS resource, perform a duplex direction change (e.g., monitor DL operations), and then transmit a second SRS resource corresponding to the AS SRS.

At 745, UE 110 can determine whether DL operations (e.g., DL monitoring) is performed. If for example, UE 110 indicated at 310 of FIG. 3 that DL operations are not performed, then method 700 proceeds to 735. Otherwise, method 700 proceeds to 755. At 735, UE 110 transmits a first and then a second SRS resource without performing DL operations.

At 755, UE 110 performs DL operation but does not transmit SRS resource of an SRS resource set.

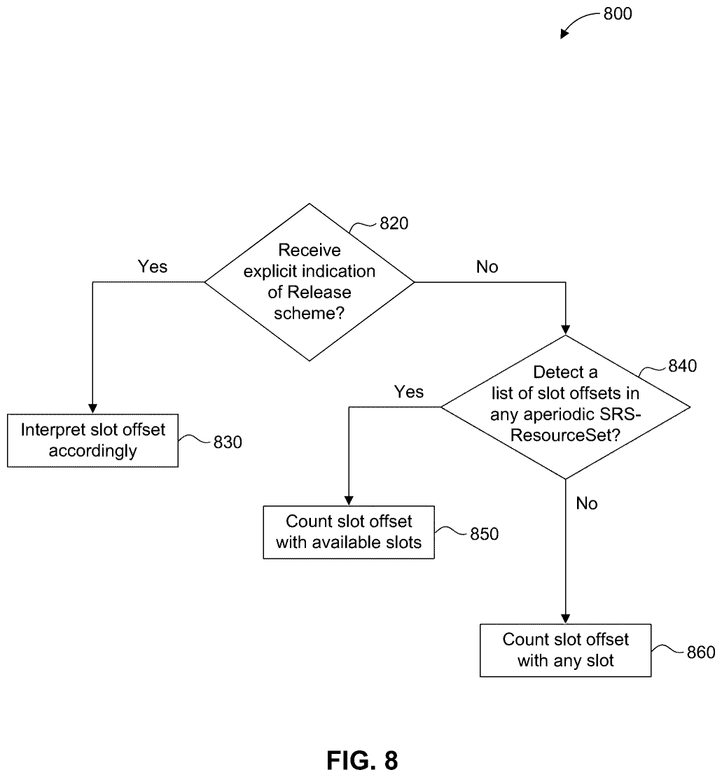

FIG. 8 illustrates example method 800 for a UE configuring a flexible slot offset for AS SRS, according to some embodiments of the disclosure. For explanation purposes and not a limitation, FIG. 8 may be described with reference to elements from earlier FIGS. Method 800 can be performed by UE 110 of FIG. 1, or system 200 of FIG. 2. At 820, UE 110 determines whether an explicit indication of the release scheme of 3GPP implemented (e.g., Rel-15/16, Rel-17) is received from BS 120. When an explicit indication is received, method 800 proceeds to 830. Otherwise, method 800 proceeds to 840.

At 830, UE 110 interprets slot offsets according to the explicit indication received. For example, if the indication is for Rel-15/16, then UE 110 counts any slot in the determination of the slot offset. If the indication is for Rel-17, then UE 110 counts only available slots in the determination of the slot offset.

At 840, UE 110 determines whether a list of slot offsets is detected in any aperiodic SRS-ResourceSet. When a list of slot offsets is detected, method 800 proceeds to 850. Otherwise, method 800 proceeds to 860.

At 850, UE 110 determines a slot offset counting only available slots.

At 860, UE 110 determines a slot offset counting any slot.

### At 350:

BS 120 can receive SRS (as described above) and assess UL propagation channels. When the UL and DL channels are reciprocal (e.g., phase continuity is maintained between UL and DL channels), BS 120 can also use the received SRS signals to estimate a downlink propagation channel corresponding to the received SRS.

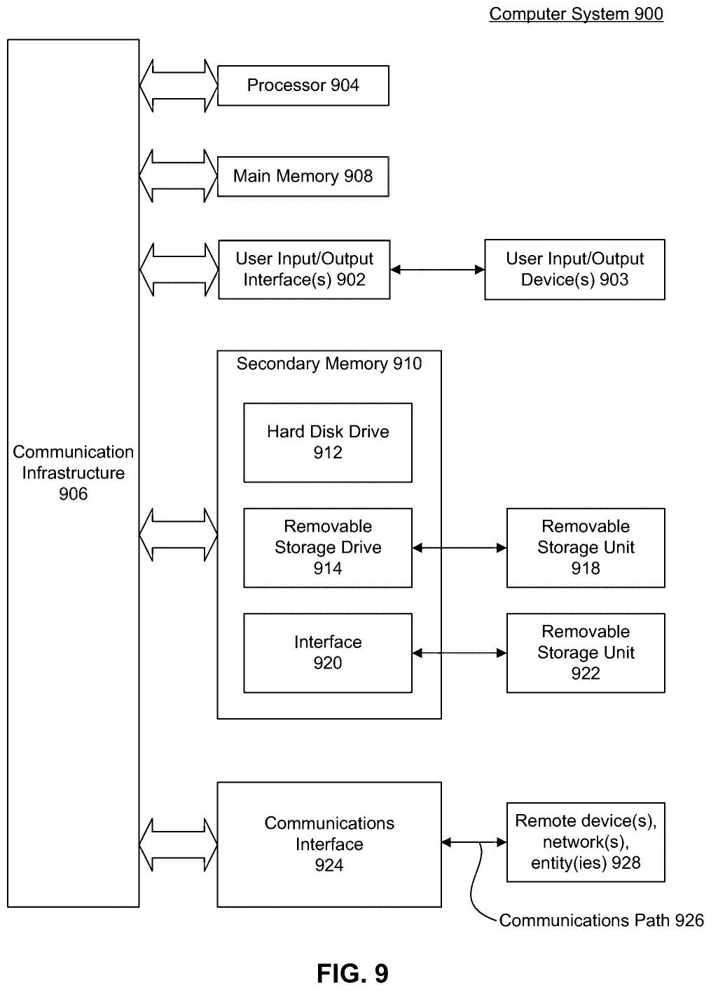

Various embodiments can be implemented, for example, using one or more well-known computer systems, such as computer system 900 shown in FIG. 9. Computer system 900 can be any well-known computer capable of performing the functions described herein. For example, and without limitation, system 200 of FIG. 2, methods 600 of FIG. 6, 700 of FIG. 7, and 800 of FIG. 8 (and/or other apparatuses and/or components shown in the figures) may be implemented using computer system 900, or portions thereof.

Computer system 900 includes one or more processors (also called central processing units, or CPUs), such as a processor 904. Processor 904 is connected to a communication infrastructure 906 that can be a bus. One or more processors 904 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 also includes user input/output device(s) 903, such as monitors, keyboards, pointing devices, etc., that communicate with communication infrastructure 906 through user input/output interface(s) 902. Computer system 900 also includes a main or primary memory 908, such as random access memory (RAM). Main memory 908 may include one or more levels of cache. Main memory 908 has stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to some embodiments, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

The operations in the preceding embodiments can be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (software) stored thereon is also referred to herein as a computer program product or program storage device. This includes, but is not limited to, computer system 900, main memory 908, secondary memory 910 and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use embodiments of the disclosure using data processing devices, computer systems and/or computer architectures other than that shown in FIG. 9. In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure or the appended claims in any way.

While the disclosure has been described herein with reference to exemplary embodiments for exemplary fields and applications, it should be understood that the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative embodiments may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the disclosure should not be limited by any of the above-described exemplary embodiments, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver; and
a processor coupled to the transceiver, configured to:
transmit via the transceiver, a capability report for antenna switching (AS) Sounding Reference Signals (SRS), wherein the capability report is associated with a plurality of receive antenna of the UE;
receive via the transceiver, SRS instructions based on the capability report;
transmit via the transceiver, a first temporary capability reduction for a duration; and
transmit via the transceiver, a first SRS according to the first temporary capability reduction and the SRS instructions.

2. The UE of claim 1, wherein to maintain phase continuity, the processor is configured to: calibrate one or more SRS ports participating in the AS SRS to transmit with substantially a same transmit power.

3. The UE of claim 1, wherein the processor is further configured to:
determine that a second SRS overlaps an other transmission in a time domain;
determine that the other transmission has an absolute priority over the second SRS; and
transmit via the transceiver, the other transmission but not the second SRS.

4. The UE of claim 1, wherein the processor is further configured to:
determine that a second SRS overlaps an other transmission in a time domain;
determine that the other transmission does not have an absolute priority over the second SRS; and
transmit via the transceiver, the second SRS.

5. The UE of claim 4, wherein the processor is further configured to:
scale a transmit power corresponding to the other transmission to satisfy a radio frequency requirement; and
transmit via the transceiver, the other transmission.

6. The UE of claim 1, wherein the processor is further configured to:
determine that the UE cannot maintain phase continuity with a duplexing direction change between a first SRS resource and a second SRS resource; and
monitor a downlink (DL) channel without transmitting the first or the second SRS resource.

7. The UE of claim 1, wherein the processor is further configured to:
determine that the UE can maintain phase continuity with a duplexing direction change between a first SRS resource and a second SRS resource;
transmit via the transceiver, the first SRS resource;
subsequent to the transmission of the first SRS resource, monitor a downlink (DL) channel; and
subsequent to the monitoring, transmit via the transceiver, the second SRS resource.

8. The UE of claim 1, wherein the processor is further configured to:
detect a list of slot offsets in an aperiodic SRS-ResourceSet; and
determine slots for a slot offset based on available slots.

9. The UE of claim 1, wherein the capability report includes a bitmap, wherein a bit of the bitmap corresponds to an SRS transmit port switching capability.

10. The UE of claim 1, wherein the first temporary capability reduction is carried via radio resource control (RRC) signaling, Media Access Control (MAC)-control element (CE) signaling, or layer 1 signaling.

11. The UE of claim 1, wherein the first temporary capability reduction corresponds to a first predefined time window, wherein the processor is further configured to transmit via the transceiver, a second temporary capability reduction outside of the first predefined time window.

12. A base station (BS), comprising:
a transceiver; and
a processor coupled to the transceiver, configured to:
receive via the transceiver, a capability report for antenna switching (AS) Sounding Reference Signals (SRS), wherein the capability report is associated with a plurality of receive antenna of a user equipment (UE);
transmit via the transceiver, AS SRS instructions based on the capability report to the UE;
receive via the transceiver, a first temporary capability reduction for a duration from the UE;
receive via the transceiver, a first SRS and a second SRS according to the first temporary capability reduction and the AS SRS instructions from the UE;
measure an uplink propagation channel of the UE based on the first SRS and the second SRS; and
estimate a downlink propagation channel of the UE based on the first and the second SRS.

13. A method of operating a user equipment (UE):
transmitting a capability report for antenna switching (AS) Sounding Reference Signals (SRS), wherein the capability report is associated with a plurality of receive antenna of the UE;
receiving SRS instructions based on the capability report;
transmitting a first temporary capability reduction for a duration; and
transmitting a first SRS according to the first temporary capability reduction and the SRS instructions.

14. The method of claim 13, further comprising maintaining phase continuity by calibrating one or more SRS ports participating in the AS SRS to transmit with substantially a same transmit power.

15. The method of claim 13, further comprising:
determining that a second SRS overlaps an other transmission in a time domain;
determining that the other transmission has an absolute priority over the second SRS; and
transmitting the other transmission but not the second SRS.

16. The method of claim 13, further comprising:
determining that a second SRS overlaps an other transmission in a time domain;
determining that the other transmission does not have an absolute priority over the second AS SRS; and
transmitting the second SRS and the other transmission, wherein a transmit power corresponding to the other transmission is scaled to satisfy a radio frequency requirement.

17. The method of claim 13, further comprising:
determining that the UE cannot maintain phase continuity with a duplexing direction change between a first SRS resource and a second SRS resource; and
monitoring a downlink (DL) channel without transmitting the first or the second SRS resource.

18. The method of claim 13, further comprising:
determining that the UE can maintain phase continuity with a duplexing direction change between a first SRS resource and a second SRS resource;
transmitting the first SRS resource;
subsequent to the transmitting of the first SRS resource, monitoring a downlink (DL) channel; and
subsequent to the monitoring, transmitting the second SRS resource.

19. The method of claim 13, further comprising:
detecting a list of slot offsets in an aperiodic SRS-ResourceSet; and
determining slots for a slot offset based on available slots.

20. The method of claim 1, wherein the capability report includes a bitmap, wherein a bit of the bitmap corresponds to an SRS transmit port switching capability.
